(19) United States
(12) Patent Application Publication
(10) Pub. No.: US 2021/0121912 A1
(43) Pub. Date: Apr. 29, 2021

(54) SYSTEM FOR POST-PROCESSING OF ENGINEERED-WOOD FENCE PICKETS

(71) Applicant: LOUISIANA-PACIFIC CORPORATION, Nashville, TN (US)

(72) Inventors: JARROD KEVIN LINE, BRENTWOOD, TN (US); HEIDI TURNER, NASHVILLE, TN (US)

(21) Appl. No.: 17/084,218

(22) Filed: Oct. 29, 2020

Related U.S. Application Data
(60) Provisional application No. 62/927,147, filed on Oct. 29, 2019.

(51) Int. Cl. B05D 3/12; B24B 21/04; B05D 1/02; B05D 7/06; B05D 7/00; B05B 16/20

(52) U.S. Cl. CPC B05D 3/12; B24B 21/04; B05B 16/20; B05D 7/06; B05D 7/5483; B05D 1/02

(57) ABSTRACT

A method and system for post-processing of engineered-wood fence pickets or similar fencing components. A post-processing line in the manufacturing factory or facility, or in a post-processing location, includes a special edge-sanding process and apparatus with one or more side sanders to treat the rough edges of the engineered-wood fence picket after sawing. The edge-sanding process produces a smooth side surface on the edges, significantly reduces the number of loose fibers and/or strands, and fills in and/or reduces void spaces. After sanding, the pickets on the belt pass through an apparatus for application of a primer to the processed picket edges. Acutely-angled limited fan sprayers provide complete coverage of the edges with primer at a particular coating thickness required for encapsulation and protection of the fence picket product. The limited fan sprayers may be positioned at varying angles and orientations with respect to the belt and pickets.

This application claims benefit of and priority to U.S. Provisional App. No. 62/927,147, filed Oct. 29, 2019, which is incorporated herein by specific reference in its entirety for all purposes.

### FIELD OF INVENTION

This invention relates to a method and system for post-processing of engineered-wood fence pickets or similar fencing components.

### SUMMARY OF INVENTION

This invention relates to a method and system for post-processing of engineered-wood fence pickets or similar fencing components. A fence picket (or other fencing component) may be made from treated engineered-wood products, including, but not limited to, oriented-strand board (OSB), fiberboard, laminated strand lumber (LSL), plywood or laminated veneer lumber (LVL). Post-processing is the further processing of the fence picket after the primary manufacturing process, an example of which is disclosed is U.S. patent application Ser. No. 16/189,995, filed Nov. 13, 2018, which is incorporated herein in its entirety by specific reference for all purposes.

A post-processing line in the manufacturing factory or facility, or in a post-processing location, in accordance with the present invention, starts with a special edge-sanding process and apparatus. An engineered-wood fence picket has rough edges after sizing to a particular width (e.g., 6 inches), and/or after profiling, as a result of the interaction between the engineered wood material and the saw(s). The edges also present loose fibers and expose void spaces, which are formed during the manufacturing of the engineered wood material itself. The edge sanding process of the present invention, as described below, produces a smooth side surface on the edges, significantly reduces the number of loose fibers and/or strands, and fills in and/or reduces void spaces. As a result, a smoother, more even edge surface is produced, with a lower consumption of primer (as described below).

In several embodiments, the present invention comprises at least one side sander that processes the edges of the picket as described above, in preparation for priming. The fence picket is transported on a belt through one or more pairs of rotary side sanders. Each side sander comprises a rotary wheel with circumferentially-positioned sanding material or elements. As the wheel rotates in a direction opposite the belt travel direction, the sanding material contacts and smooths the respective edge of the picket as it passes by. The sanding material may comprise stone, a sanding belt, or a plurality of flexible sanding flaps (e.g., paper based) extending outward from the outer circumference. The rotational speed of the wheel may vary, depending on the desired amount of sanding. Likewise, the distance of the center of the wheel from the belt may vary, to accommodate different widths of the picket or component, or to adjust the amount of pressure applied by the sanding material to the respective edge of the picket.

A pair of side sanders may be positioned to simultaneously smooth opposing edges of the picket as it passes. This ensures that equal pressure or force will be apply to the opposite edges of the picket during the sanding process. Dust or sanding debris can be removed by suction ventilation tubes, extending from a box or housing for each sander. A second pair of oppositely-placed side sanders provides follow-up treatment of the edges. The sanding material of the second pair may be the same as or different than the sanding material of the first pair of side sanders. In some embodiments, the sanding material of the second pair is a finer or smaller grit than the sanding material of the first pair of side sanders, so that the second pair provides a smoother finish and finer particles to help ensure the filling of voids in the engineered wood material along the edge. After sanding, the pickets on the belt pass through an apparatus for application of a primer to the processed picket edges. Primer application on the edges is an important element for engineered-wood fence pickets, as edge priming helps encapsulate the product, and increases its resistance to weather and decay as well as providing a base for an aesthetic finish. Prior art paint sprayers and methods (e.g., brushes, 180° or 90° fan sprayers) do not meet the requirements needed for engineered-wood fence pickets, and their use results in partial or thin coverage of the edges and a significant amount of wasted material. The present invention comprises the use of acutely-angled limited fan sprayers or fan coaters (air atomized, air-assisted, or non-air-assisted), which provide complete coverage of the edges and/or the face with primer, create suitable finishes, and provide the particular coating thickness required for the protection of the product in a timely fashion in a post-processing line process. The limited fan sprayers and/or fan coaters may be positioned at varying angles and orientations with respect to the belt and pickets.

### BRIEF DESCRIPTION OF THE DRAWINGS

FIG. 1 is a diagram of a post-processing method in accordance with an exemplary embodiment of the present invention.

FIG. 2 shows a top view of an edge sander station on a post-processing line in accordance with an exemplary embodiment of the present invention.

FIG. 3 shows a top view of an embodiment of a primer or paint booth on a post-processing line.

FIG. 4 shows a cross-sectional view across the width of a picket passing by an edge primer nozzle.

### DETAILED DESCRIPTION OF EXEMPLARY EMBODIMENTS

In several exemplary embodiments, the present invention comprises a system for post-processing a fence picket (or other fencing component) made from treated engineered-wood products, including, but not limited to, oriented-strand board (OSB), fiberboard, laminated strand lumber (LSL), plywood or laminated veneer lumber (LVL). Engineered-wood products provide the authentic look and appeal of real wood, but with the advantages of treated engineered wood. Post-processing is the further processing of the fence picket after the primary manufacturing process, an example of which is disclosed is U.S. patent application Ser. No. 16/189,995, filed Nov. 13, 2018, which is incorporated herein in its entirety by specific reference for all purposes.

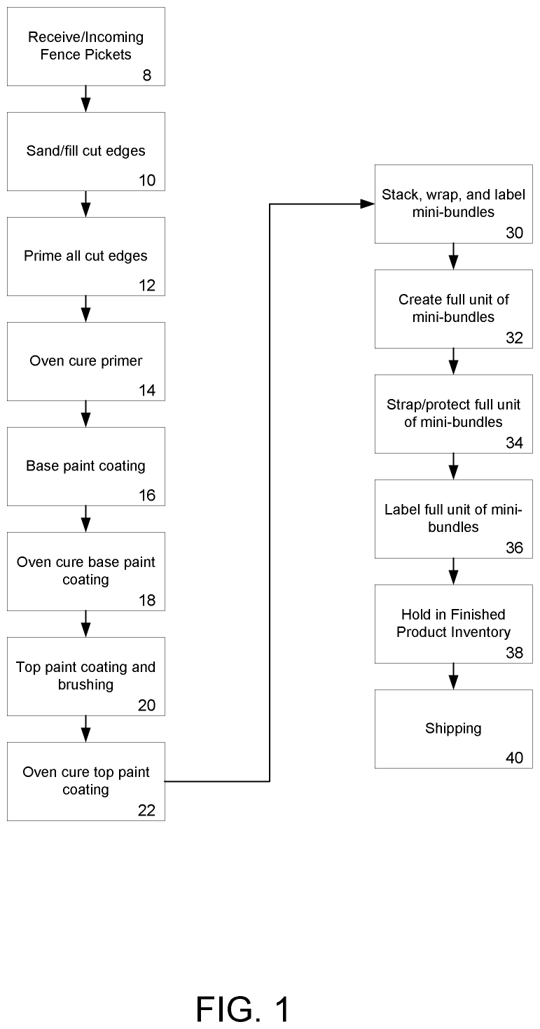

A post-processing line in the manufacturing factory or facility, or in a post-processing location, in accordance with the present invention, is shown in FIG. 1. Raw engineered fence pickets are received 8 after being produced from a primary manufacturing process as described above. Pickets are placed on the post-processing line, and initially subjected to a special edge-sanding process and apparatus 10 (as described below). An engineered-wood fence picket has rough edges after cutting or sizing to a particular width (e.g., 6 inches), and/or after profiling, as a result of the interaction between the engineered wood material and the saw(s). The edges also present loose fibers and expose void spaces, which are formed during the manufacturing of the engineered wood material itself. The edge sanding process of the present invention, as described below, produces a smooth side surface on the edges, significantly reduces the number of loose fibers and/or strands, and fills in and/or reduces void spaces. As a result, a smoother, more even edge surface is produced, with a lower consumption of primer (as described below).

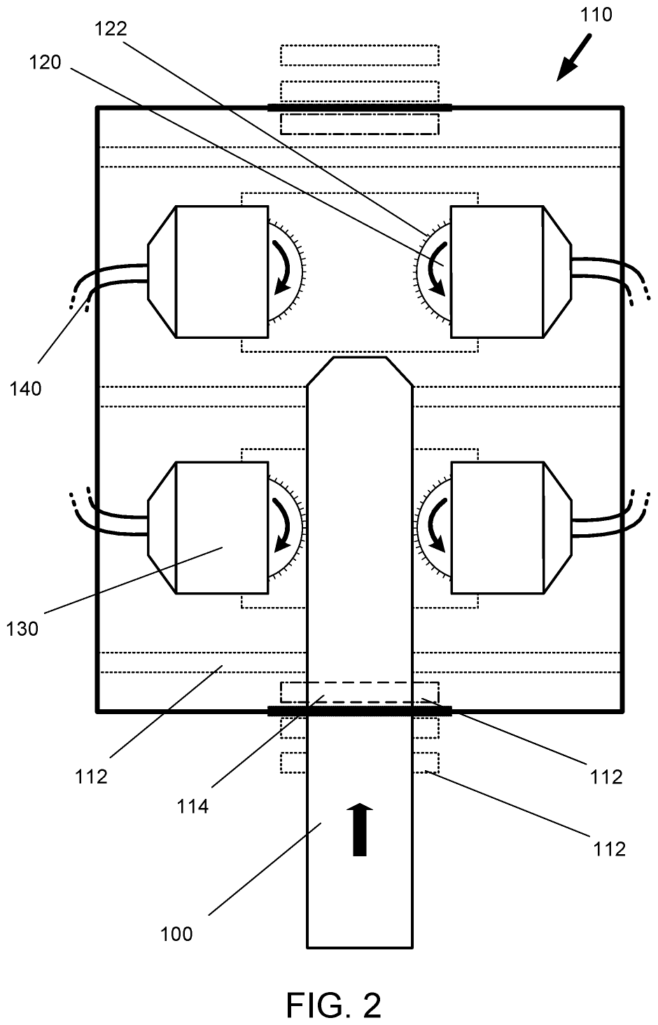

FIG. 2 shows an example of a side sander station 110 that receives and processes the edges of the picket 100 as described above, in preparation for priming. In the embodiment shown, the fence picket is transported on a belt and then rollers 112 through one or more pairs of rotary side sanders 120. Rollers 112 generally are underneath and support the fence picket, although one or more top-side rollers 114 may be used to help hold the fence pickets in place as they are process. Each side sander 120 comprises a rotary wheel or drum with circumferentially-positioned and outstretched sanding materials, media, or elements 122. The sanding material may comprise stone, abrasives, a sanding belt, or a plurality of flexible sanding flaps (such as, but not limited to, paper-based abrasive strips) extending outward from the outer circumference. Other forms of side sanders may be used, such as fixed disks with attached sanding materials or media, grinding wheels with fixed abrasive elements or sand materials or media, or similar devices.

In the embodiment shown, the wheel rotates in a direction opposite the belt direction (and thus the picket direction). In alternative embodiments, the side sanders may move or rotate in different directions, including at an angle to the plane of the picket faces, or in an opposite direction to the direction of belt travel. The side sanders also may vibrate, oscillate or rotate along the edges at variable angles to the plane of the picket faces.

As the picket edges pass the side sanders, the sanding or abrasive material contacts and smooths the respective edge of the picket as the edge passes by. The rotational speed of the wheel may vary, depending on the desired amount of sanding. Likewise, the position of the side sanders with respect to the belt may be adjusted to accommodate different widths of the picket or fence component, or to adjust the amount of pressure applied by the sanding material to the respective edge of the picket. Thus, for example, the distance of the center of the wheel from the belt may vary, to accommodate different widths of the picket or component, or to adjust the amount of pressure applied by the sanding material to the respective edge of the picket. This process removes loose engineered-wood fibers and closes or fills open pores in the edge of the engineered wood. In several embodiments, the side sanders are positioned to accomplish these purposes without reducing, or significantly reducing, the finished size or width of the picket.

As seen in FIG. 1, a pair of side sanders 120 may be positioned to simultaneously treat opposing edges of the picket as the picket passes between the side sanders. This helps to ensures that equal pressure or force will be apply to the opposite edges of the picket during the sanding process. Dust or sanding debris can be removed by suction ventilation tubes 140, extending from a box, shroud, or housing 130 for each sander. As seen in the figure, a second pair of oppositely-placed side sanders provides follow-up treatment of the edges. The sanding material of the second pair may be the same as or different than the sanding material of the first pair of side sanders. In some embodiments, the sanding material of the second pair is a finer grit (i.e., higher grit number) than the sanding material of the first pair of side sanders, so that the second pair provides a smoother finish and finer particles to help ensure the filling of voids in the engineered wood material along the edge.

In several exemplary embodiments, the initial sanding material or media comprises a low grit surface, ranging from 60 to 80 grit (a commonly accepted measure of sanding media, with higher grit numbers indicating a finer treatment), with an abrasive surface comprising silicon carbide, aluminum oxide, zirconia alumina, or similar hard abrasive surface. A second surface finish using 120 grit material may be useful in further pore closure or filling. The sanding material should have a relative surface velocity and impact zone which will accomplish the goal of loose fiber removal and pore closure, but not reduce the size (e.g., width) of the product. Each machine or type of machine is different, so adjustments for position and speed may be made.

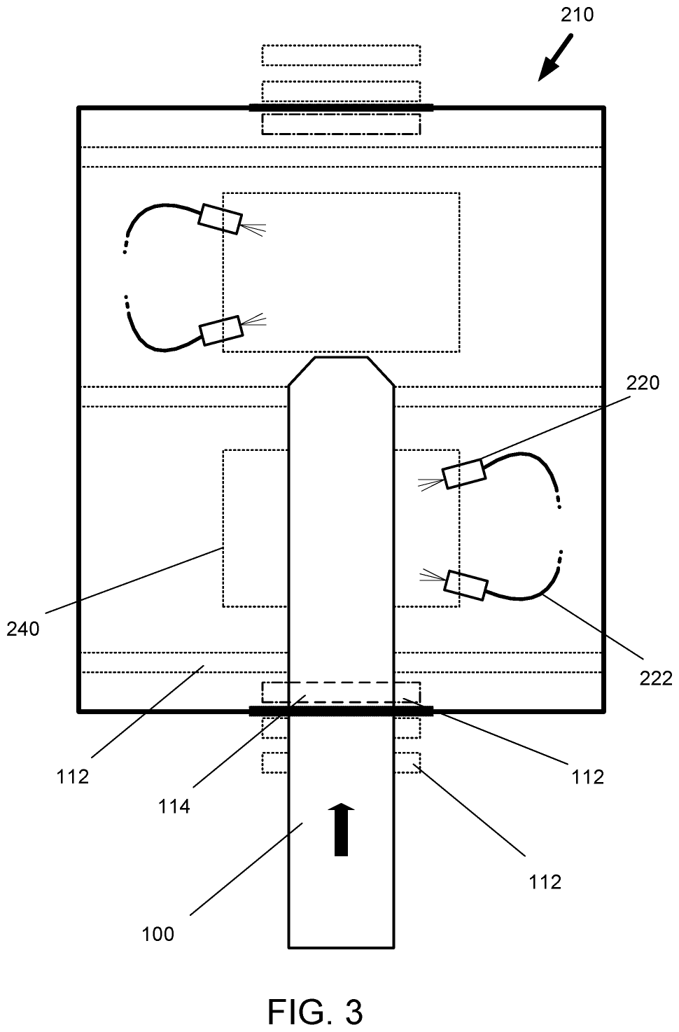

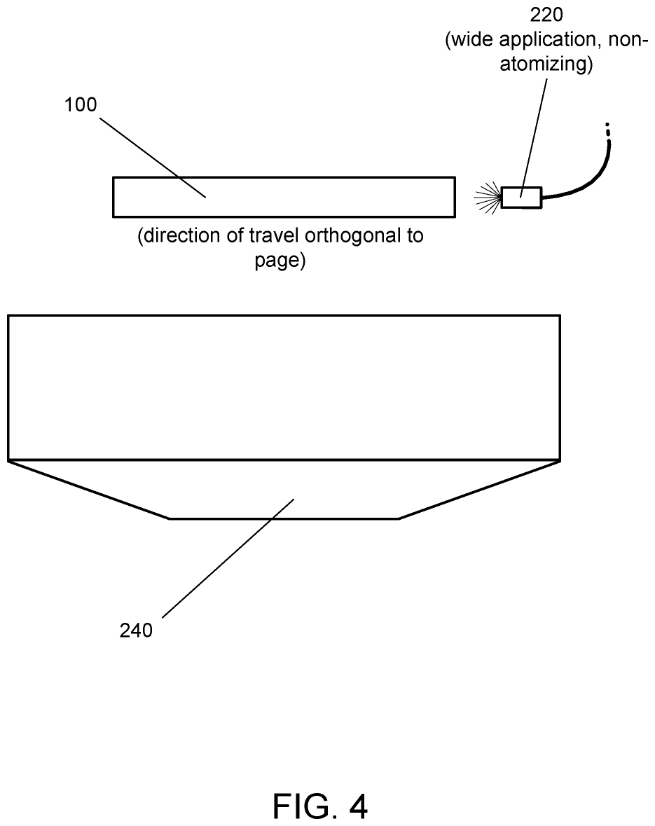

FIGS. 3 and 4 show an apparatus for application of a primer to the picket edges. Primer application on the edges is an important element for engineered-wood fence pickets, as edge priming helps encapsulate the product, and increases its resistance to weather and decay as well as providing a base for an aesthetic finish. Prior art paint sprayers and methods (e.g., brushes, 180° or 90° fan sprayers, vacuum coaters) do not meet the requirements needed for engineered-wood fence pickets, and their use results in partial or thin coverage of the edges and a significant amount of wasted material. The present invention comprises the use of acutely-angled limited fan sprayers or fan coaters that do atomize the paint, which provide complete coverage of the edges with primer, as well as providing the particular coating thickness required for the protection of the product in a timely fashion in a post-processing line process. The limited fan sprayers or fan coaters may be positioned at varying angles and orientations with respect to the belt and pickets.

In accordance with an exemplary embodiment, after edge sanding, a picket 100 travels on the belt and rollers into a priming booth or station 210, as seen in FIG. 3. As the picket travels through the priming booth, at least one angled limited fan sprayer or fan coater is positioned to spray primer through one or more nozzles 220 (supplied primer or paint coating through supply lines 222) at an edge. As seen in FIG. 4, a pair of spray nozzles 220 are positioned on level with the picket edge, each angled at variable degrees from a transverse axis of the picket (i.e., orthogonal with respect to the longitudinal axis of the picket).

In the figure shown, the pair of nozzles on each side are angled in opposite directions, i.e., the first nozzle is directed slightly away from the entrance into the booth (i.e., at an angle ranging between 30 and 90 degrees, more preferably between 30 and 60 degrees with respect to the longitudinal axis of the picket), while the second nozzle is directed toward the entrance into the booth (i.e., at an angle ranging between 30 and 90 degrees, more preferably between 30 and 60 degrees, with respect to the longitudinal axis of the belt). Each nozzle also may be positioned so that the plane of the spray is at an angle with the respect to the plane of the belt and the picket. This positioning helps to ensure that the edges of the picket, including any voids and gaps that are filled with fine material from the sanding process or that may be remaining thereafter, are completely covered and/or coated by the primer (as discussed above).

The layout of the spray booth is important to enable the product to be finished with efficiency. Atomizing sprayers used in the present invention possess a narrow spray angle or wedge from approximately 15 to 30 degrees in width, with an application zone just slightly wide than the maximum width of the board edge being coated. Non-atomizing sprayers can have a larger spray angle or wedge (i.e., overspray) from approximately 60 to 120 degrees in width, where the overspray is collected by at least one paint recovery pan 240, usually positioned below the spray area, and then recycled into a paint recovery system for eventual re-use. A paint recovery pan and system may be used with atomizing sprayers as well.

The spray booth shown in FIG. 3 shows a pair of nozzles located at offset positions within the spray booth. The nozzles also may be placed in other relative positions, such as in directly opposite positions. Nozzles may also alternate on opposite sides, with no nozzles in directly opposite positions.

In one exemplary embodiment, after the cut edges are primed 12, the pickets are cured, typically in an oven 14, and dried. The pickets are then sent through a spray booth for priming or base paint coating 16 of the faces of the picket (including any remaining unprimed or unpainted surfaces or ends of the picket). The base paint coating is cured in an oven 18 and dried. A top paint coating is applied (which may include brushing) 20. The pickets are then oven cured 22 and dried.

After priming and/or coating of the picket is complete, the pickets are dried, the stacked, wrapped and labeled in mini-bundles 30. The mini-bundles are collected to create a full unit 32, which is strapped and wrapped or boxed or otherwise protected 34 for shipping. The full unit is then labeled 36 and held in finished product inventory 38 until shipped 40.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A processing method, comprising:
receiving a raw engineered-wood fence component with two edges;
on a post-processing line with a belt, transporting the raw engineered-wood fence component in a line transport direction;
passing the raw fence component on the belt through a first pair of edge-sanders, each configured to apply a respective sanding surface to the respective edges of the raw fence component; and
after passing the raw fence component through the first pair of edge-sanders, passing the fence component on the belt through a first array of angled fan sprayers, configured to apply a first coating of primer to the respective edges of the fence component.

2. The method of claim 1, further comprising the step of:
after passing the raw fence component through the first pair of edge-sanders, passing the fence component on the belt through a second pair of edge-sanders, configured to apply a respective sanding surface to the respective edges of the fence component;
further wherein the second pair of edge-sanders are configured to fill voids or holes in the respective edges of the fence component with material produced by the application of the respective sanding surface to the respective edge of the fence component.

3. The method of claim 1, further comprising the step of:
after passing the fence component through the first array of angled fan sprayers, passing the fence component on the belt through a second array of angled fan sprayers, configured to apply a second coating of primer to the respective edges of the fence component.

4. The method of claim 1, further comprising the step of:
after passing the raw fence component through the first pair of edge-sanders, passing the fence component on the belt through a second pair of edge-sanders, configured to apply a respective sanding surface to the respective edges of the fence component, further wherein the second pair of edge-sanders are configured to fill voids or holes in the respective edges of the fence component with material produced by the application of the respective sanding surface to the respective edge of the fence component;
further wherein the sanding surface of the second pair of edge-sanders is a finer grit than the sanding surface of the first pair of edge-sanders.

5. The method of claim 1, wherein the first pair of edge-sanders are configured to remove engineered-wood fibers from the respective edges of the raw fence component, and fill voids or holes in the respective edges of the fence component with material produced by the application of the respective sanding surface to the respective edge of the fence component, without reducing the width of the raw fence component.

6. The method of claim 1, further comprising the step of:
after passing the fence component through the first array of angled fan sprayers, passing the fence component on the belt through a second array of angled fan sprayers, configured to apply a second coating of primer to the respective edges of the fence component.

7. The method of claim 1, wherein the first array of angled fan sprayers comprise a pair of angled fan sprayers directed to each edge of the fence component, wherein a first angled fan sprayer in each of said pair is angled in the direction of travel of the fence component, and a second angled fan sprayer in each of said pair is angled against the direction of travel of the fence component.

8. The method of claim 1, wherein the engineered-wood fence component comprises oriented-strand board, laminated strand lumber, or laminated veneer lumber.

9. The method of claim 1, wherein the engineered-wood fence component is a fence picket.

10. A processing method, comprising:
receiving a raw engineered-wood fence picket made of oriented-strand board, laminated strand lumber, and/or laminated veneer lumber, said fence picket with two edges;
on a post-processing line, transporting the raw engineered-wood fence picket in a line transport direction;
passing the raw fence picket on the line through a first pair of edge-sanders, each configured to apply a respective sanding surface to the respective edges of the raw fence picket;
after passing the raw fence picket through the first pair of edge-sanders, passing the fence picket on the line through a second pair of edge-sanders, configured to apply a respective sanding surface to the respective edges of the fence picket, further wherein the second pair of edge-sanders are configured to fill voids or holes in the respective edges of the fence picket with material produced by the application of the respective sanding surface to the respective edge of the fence picket; and
after passing the raw fence picket through the first pair of edge-sanders, passing the fence picket on the line through a first array of angled fan sprayers, configured to apply a first coating of primer to the respective edges of the fence component.

11. The method of claim 10, further comprising the step of, after passing the fence component on the line through a first array of angled fan sprayers, passing the fence component through a second array of angled fan sprayers, configured to apply a second coating of primer to the respective edges of the fence component.

12. A post-processing line assembly for a fence picket with a first edge and a second edge, comprising:
an edge-sanding station, the edge-sanding station comprising a first pair of edge-sanders, each configured to apply a first respective sanding surface to the respective edges of the raw fence component; and
an edge-priming station, the edge-priming station comprising one or more first-edge angled fan sprayers configured to apply a first coating of primer to the first edge of the fence picket, and one or more second-edge angled sprayers configured to apply a first coating of primer to the second edge of the fence picket.

13. The assembly of claim 12, wherein the edge-sanding station further comprises a second pair of edge-sanders, configured to apply a second respective sanding surface to the respective edges of the fence component.

14. The assembly of claim 12, wherein the edge-sanding station is configured to remove engineered wood fiber from and fill gaps and voids in the first edge and second edge of the fence picket.

15. The assembly of claim 14, wherein the edge-sanding station is configured to not reduce the width of the fence picket.

16. The assembly of claim 12, wherein there are two first-edge angled fan sprayers, one angled in the direction of travel of the fence picket and the other angled against the direction of travel of the fence component.

17. The assembly of claim 16, wherein there are second first-edge angled fan sprayers, one angled in the direction of travel of the fence picket and the other angled against the direction of travel of the fence component.

18. The assembly of claim 12, wherein the first-edge and second-edge angled fan sprayers are arranged at an approximately 30 degree to approximately 60 degree angle with the respect to a transverse axis of the fence picket.
